(19) United States
(12) Patent Application Publication
(10) Pub. No.: US 2017/0124813 A1
(43) Pub. Date: May 4, 2017

(54) System and Method for Processing Coin Deposits and Withdrawals in an Automated Banking Machine

(71) Applicant: Canadian Imperial Bank of Commerce, Toronto (CA)

(72) Inventor: Christopher Paul Harrison MISENER, Guelph (CA)

(21) Appl. No.: 15/337,665

(22) Filed: Oct. 28, 2016

Related U.S. Application Data
(60) Provisional application No. 62/247,640, filed on Oct. 28, 2015.

(51) Int. Cl. G07F 19/00; G07D 3/00; G07D 9/06

(52) U.S. Cl. CPC G07F 19/20; G07D 9/065; G07D 3/00; G07F 19/202; G07F 19/203

(57) ABSTRACT

Systems and methods are provided for processing coin deposits and withdrawals in an automated banking machine (ABM). In one aspect, a cash management system is described. The cash management system includes a coin sorter for accepting and discriminating between a plurality of denominations of coin; at least one coin roller coupled to the coin sorter, for rolling the plurality of denominations of coin output by the coin sorter; at least one rolled coin store coupled to the at least one coin roller, for storing rolled coin in the plurality of denominations output by the at least one coin roller; and a rolled coin dispenser coupled to the at least one rolled coin store, for obtaining rolled coin requested in a withdrawal.

### CROSS-REFERENCE TO RELATED APPLICATION

This application claims priority to U.S. provisional patent application No. 62/247,640 filed on Oct. 28, 2015, the entire contents of which are incorporated herein by reference.

### TECHNICAL FIELD

The following relates to systems and methods for processing coin deposits and withdrawals in an automated banking machine.

### DESCRIPTION OF THE RELATED ART

Financial institutions typically allow for automated financial transactions using electronic telecommunications devices. These devices are commonly known in the industry as automated teller machines (ATMs), automated banking machines (ABMs), cash machines, coin recyclers, and various other terms or acronyms according to the jurisdiction in which they are used. In the follow description, the acronym ABM will be used, however, it will be appreciated that the principles discussed herein can apply to any similar device enabling automated financial transactions.

ABMs have normally be used to provide a select number of routine and frequently performed financial transactions such as banknote and cheque deposits, banknote withdrawals, bank-book updates, account information retrieval, fund transfers, and bill or invoice payments, to name a few. These currently used ABM units are either not capable of handling coins or require separate mechanisms (e.g., so called “sidecars”) to provide coin deposits and coin withdrawals. As such, much of the coin transactions at financial institutions are handled by tellers or by night deposit chutes (e.g. for small business owners). While there exists coin recycling machines, these machines are typically standalone units that accept loose coin and provide a credit to the customer in exchange. Retail applications also exist for managing cash register tills, however, these solutions are considered to not be suitable for managing coins within a financial institution's network of ABMs and underlying financial transaction system.

It is an object of the following to address at least one of the above-noted disadvantages.

### SUMMARY

A system and method are provided that enable coin deposits and withdrawals at an ABM in a closed-loop manner to enable coins to be immediately available within a financial institution's circulation by providing the ability to package loose coin (e.g., by rolling the coin into a substrate such as a paper packing, normally referred to as a “roll”) and dispense packages (e.g. rolled) coin in an automated fashion.

In one aspect, there is provided a cash management system comprising: a coin sorter for discriminating between a plurality of denominations of coin accepted by a coin acceptor; at least one coin roller coupled to the coin sorter, for rolling the plurality of denominations of coin output by the coin sorter; at least one rolled coin store coupled to the at least one coin roller, for storing rolled coin in the plurality of denominations output by the at least one coin roller; and a rolled coin dispenser coupled to the at least one rolled coin store, for obtaining rolled coin requested in a withdrawal.

In another aspect, there is provided an automated banking machine (ABM) comprising: a housing supporting a display screen, a loose coin acceptor, a rolled coin dispenser, and the above cash management system.

In yet another aspect, there is provided a method for enabling cash withdrawals, the method comprising: providing, in a user interface, a banknote withdrawal option and a rolled coin withdrawal option; enabling, by the rolled coin withdrawal option, selection of one or more coin rolls for each of a plurality of coin denominations; and after detecting confirmation of selections made in either or both of the banknote withdrawal option and the rolled coin withdrawal option, instructing a banknote dispenser to dispense one or more banknotes and at least one coin roll.

In yet another aspect, there is provided a method of processing loose coin deposits, the method comprising: in response to receiving a plurality of loose coins, counting, validating, and sorting the plurality of loose coins; and for each of at least one coin denomination: performing at least one of: i) filling a partially filled roll if available from a previous loose coin deposit and rolling the filled roll, and ii) completing a partial stack of coin and rolling the completed stack; performing at least one of: i) obtaining an empty roll, filling the empty roll, and rolling the filled roll, and ii) rolling a newly completed stack of coin; and adding at least one coin roll to a rolled coin store in an ABM. A roll can be either a pre rolled coin “tube” or a paper sheet that can be used to roll the loose coin.

In yet another aspect, there is provided a method of processing rolled coin deposits in an ABM, the method comprising: determining and validating a number of newly rolled coin rolls; updating values indicative of a stock of rolled coins in the ABM; determining if at least a portion of the stock of rolled coins in the ABM should be removed from the ABM; and when it is determined that stock of rolled coins should be removed, sending a request for same via an ABM communication network.

In yet another aspect, there is provided a method of processing cash withdrawals, the method comprising: determining a number of withdrawn coin rolls; updating values indicative of a stock of rolled coins in the ABM; determining if at least a portion of the stock of rolled coins in the ABM should be added to the ABM; and when it is determined that stock of rolled coins should be added, sending a request for same via an ABM communication network.

### BRIEF DESCRIPTION OF THE DRAWINGS

Embodiments will now be described by way of example only with reference to the appended drawings wherein:

FIG. 1 is a diagram illustrating a set of ABM units;

FIG. 2 is a schematic diagram of a system for accepting and dispensing cash in an ABM unit;

FIG. 3 is a schematic diagram of a system for rolling loose coin and enabling rolled coin to be dispensed from an ABM unit;

FIG. 4 is a plan view of a schematic diagram for a rolled coin vault interfacing with multiple ABM units;

FIG. 5 is a plan view of a schematic diagram for local and shared rolled coin vaults for multiple ABM units;

FIG. 6 is a block diagram illustrating an example of a configuration for a cash management software system utilized by an ABM unit;

FIG. 7 is a flow chart illustrating operations performed in processing a loose coin deposit at an ABM unit;

FIG. 8 is a flow chart illustrating operations performed in processing a rolled coin deposit at an ABM unit;

FIG. 9 is a is a screen shot of an example of a user interface for interacting with an ABM unit to perform a cash withdrawal;

FIG. 10 is a flow chart illustrating operations performed in processing a rolled coin withdrawal at an ABM unit;

FIG. 11 is a flow chart illustrating operations performed in management account information based on a loose coin deposit at an ABM unit;

FIG. 12 is a flow chart illustrating operations performed in management account information based on a rolled coin deposit at an ABM unit;

FIG. 13 is a flow chart illustrating operations performed in managing rolled coin stock in a rolled coin vault in an ABM unit based on a coin deposit;

FIG. 14 is a flow chart illustrating operations performed in managing rolled coin stock in a rolled coin vault in an ABM unit based on a rolled coin withdrawal; and

FIG. 15 is an exploded partial perspective view of a system for processing coin deposits in a set of ABM units.

### DETAILED DESCRIPTION

It has been recognized that by incorporating coin rolling and rolled coin storage and retrieval into an ABM unit, loose and rolled coin can be circulated directly from one or more ABM units and integrated into an existing ABM and financial institution network.

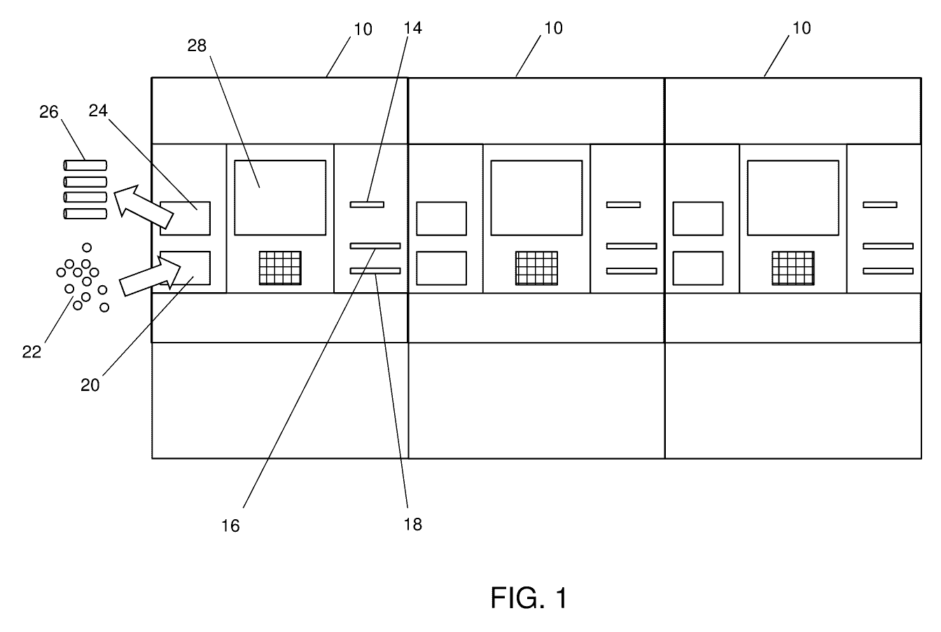

Turning now to the figures, FIG. 1 illustrates an exterior view of an ABM unit 10. In this example, three ABM units 10 are arranged adjacent to each other as a multi-unit set of ABMs 10. The ABM unit 10 includes a card reader 14, a banknote dispenser outlet 16, and an envelope deposit slot 18 as is well known in the art. The ABM unit 10 also includes a coin deposit acceptor 20 for accepting loose coin 22, and a rolled coin dispenser 24 for dispensing rolled coin 26. It can be appreciated that either (or both) the coin deposit acceptor 20 or the rolled coin dispenser 24 can be configured to also accept rolled coin deposits. The ABM unit 10 also includes a display screen 28 to enable user interactions with the ABM unit 10, e.g., to conduct automated financial transactions, review banking information, etc. It can be appreciated that while a series of ABM units 10 are shown in FIG. 1, more or fewer ABM units 10 may be provided together, including single standalone ABM units 10 and larger multi-unit sets, e.g., at financial institution retail branches. It can also be appreciated that FIG. 1 illustrates only one example of an ABM unit configuration, and the coin handling functionality discussed herein can be adapted for other types, sizes, and configurations of ABM units 10.

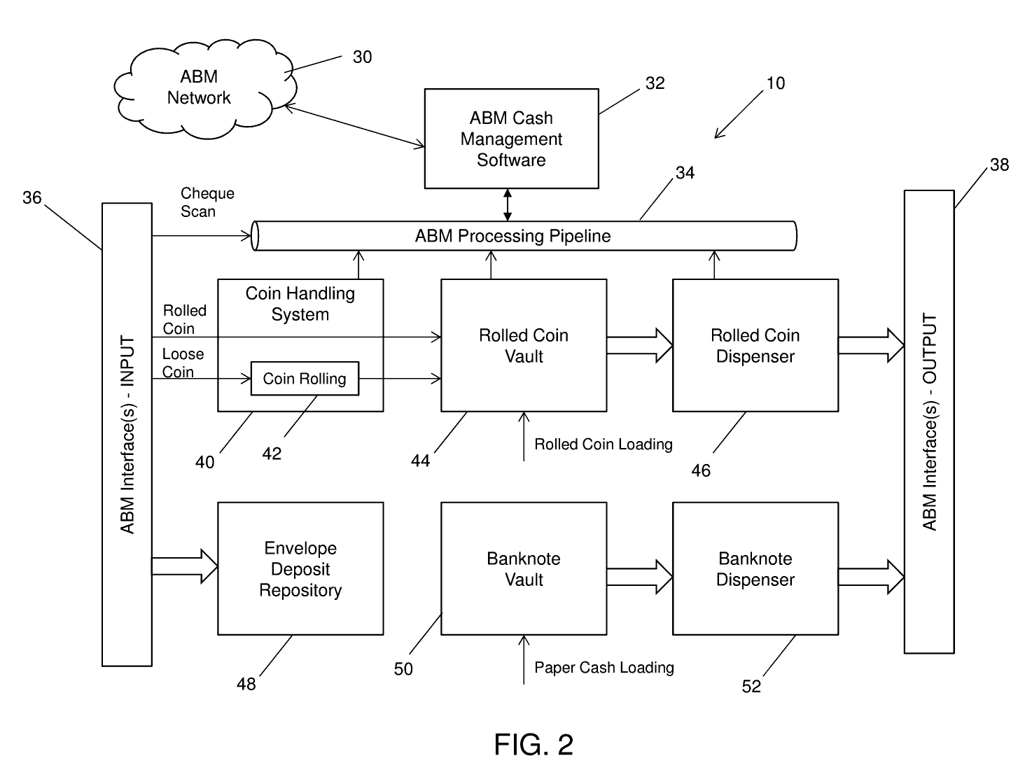

FIG. 2 schematically illustrates a cash processing system utilized by the ABM unit 10; which is connected to an ABM network 30 provided by a financial institution. The cash processing system includes ABM cash management software 32 for tracking deposits and withdrawals in order to update accounts in the ABM network 30, for obtaining account and other financial information from the ABM network 30, and at least in part controlling automated banking functionality within the ABM unit 10 via an ABM processing pipeline 34. The cash processing system includes one or more ABM input interfaces 36 for accepting cash deposits (e.g., the coin deposit acceptor 20, rolled coin dispenser 24, envelope deposit slot 18 shown in FIG. 1), and one or more ABM output interfaces 38 (e.g., the coin dispenser 24, banknote dispenser outlet 16 shown in FIG. 1). The ABM unit 10 can also include other interfaces for providing inputs, for example, a cheque scanner (not shown) for enabling cheque scanning directly into the processing pipeline 34 of the ABM unit 10. It can be appreciated that cheques and banknotes can also be deposited into an envelope deposit repository 48 or other containment unit for storing deposited envelopes for subsequent processing as is known in the art.

The cash processing system shown in FIG. 2 enables not only banknote transactions, but also coin transactions in order to allow coin deposits and withdrawals to be automated and immediately reconciled with the ABM network 30, but also to provide a circulation of coins amongst ABM units 10 while minimizing coin loading and unloading functions. That is, by containing the coin processing such as coin rolling and rolled coin withdrawals directly in the ABM unit 10, costly armoured car pick ups and deliveries can be minimized. Moreover, customers that utilize coin (e.g. small retail businesses) can perform coin and till management functions at any time due to the convenience and automated functionality of such an ABM unit 10. As illustrated in FIG. 2, a coin handling system 40 is included in the ABM unit 10 for accepting loose coin 22 and can be configured to also accept pre-rolled coin 26. The coin handling system 40 includes one or more coin rolling mechanisms 42, preferably one coin rolling mechanism 42 for each denomination of loose coin 22 that can be deposited. It can be appreciated that the coin rolling mechanism 42 can instead be configured to accept and roll multiple denominations in the same device and therefore the delineations between coin rollers made herein are for illustrative purposes only.

The coin handling system 40 transfers rolled coin 26 into a secured rolled coin vault 44. As illustrated in FIG. 2, the rolled coin vault 44 can also be externally loaded. The rolled coin vault 44 is not only able to accept and store rolled coin 26, the rolled coin vault 44 is also operable to output rolled coin 26, in requested quantities and denominations to a rolled coin dispenser 46. The rolled coin dispenser 46 is communicable with the rolled coin dispenser 24 to enable rolled coin to be withdrawn by a user. Although not shown in FIG. 2, the rolled coin dispenser 46 (or a separate but similarly functioning module) can be configured to receive rolled coin 26 via the rolled coin dispenser 24 (or separate and suitably sized inlet) to deposit rolled coin 26 into the rolled coin vault 44. For example, customers having pre-rolled coins can be provided with an option to deposit the rolled coin 26 directly without requiring the coin rolling stage.

The cash processing system also includes a banknote vault 50 for storing banknotes to enable banknote withdrawals via a banknote dispenser 52 and the banknote dispenser outlet 16 as is known in the art.

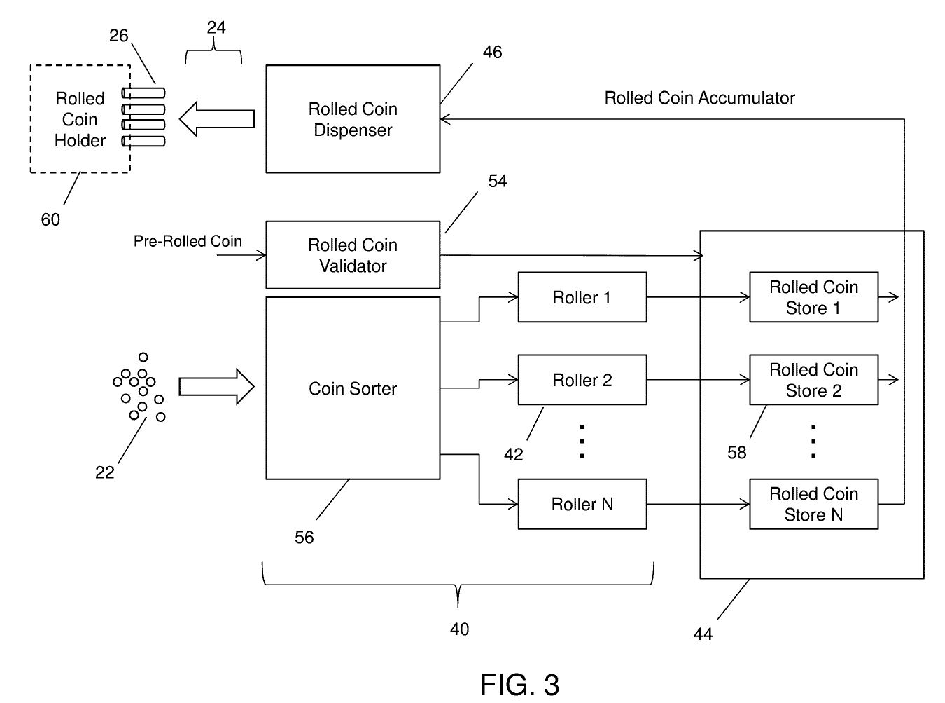

Further details regarding the coin handling system 40 and rolled coin handling modules are shown in FIG. 3. The coin handling system 40 in the example shown in FIG. 3 includes a coin sorter 56 that receives loose coin 22; and a rolled coin validator 54 configured to receive pre-rolled coin 26, validate the pre-rolled coin 26, and transfer deposited pre-rolled coin 26 directly into the rolled coin vault 44. The rolled coin validator 54 is thus configured not only to physically receive the rolled coin 26 but also to validate, authenticate, or verify the rolled coin 26 to ensure the expected number of coins have been rolled, a consistent denomination is included in the roll, etc. Since pre-rolled coin 26 may have been prepared manually, the rolled coin validator 54 is incorporated to enable the pre-rolled coin 26 to be immediately accounted for, rather than relying on subsequent manual validation or verification.

The coin sorter 56 is configured to receive and discriminate between a plurality of denominations of loose coin 22 to enable the same denomination to be rolled together into rolled coin 26 using one or more coin rolling mechanisms 42. As discussed above, a separate coin rolling mechanism 42 can be provided for each denomination of coin to simplify and increase throughput in separating rolled coin stores 58 in the rolled coin vault 44. In this way, rolled coin 26 of the various denominations are held in groups together in the vault 44 to simplify subsequent withdrawals of rolled coin 26 by the rolled coin dispenser 46. For example, twenty-five cent coins would be rolled and the completed twenty-five cent rolls stored together such that a request for a certain number of twenty-five cent rolls can be obtained from the corresponding rolled coin store 58, without requiring further validations or scanning of rolls to determine if they are correct. Since the ABM unit 10 is also capable of rolled coin withdrawals, such simplifications in processing are advantageously used to create a fully closed loop cash and coin handling system.

As shown in FIG. 3, the coin sorter 56 can be configured to discriminate between the plurality of coin denominations and feed each coin denomination to its designated coin rolling mechanism 42. Completed rolled coin rolls 26 are then fed into corresponding rolled coin stores 58 in the rolled coin vault 44 where they are available for use on the withdrawal side of financial transactions provided by the ABM unit 10. The rolled coin stores 58 therefore include both inlets and outlets for physically transferring rolled coin 26 into and out thereof. The rolled coin dispenser 46 is coupled to the rolled coin stores 58 via a conveyance mechanism to extract a request amount of rolled coin 26 to be dispensed via the rolled coin dispenser 24.

Optionally, as illustrated in FIG. 3 using dashed lines, the 24 can be sized and configured to interface with a rolled coin holder 60 such as a cash machine till that organizes and contains rolled coin 26. In this way, a retail customer can not only deposit loose coin 22 but also withdraw suitable amounts of rolled coin 26 to assist in coin management without requiring a visit to a bank teller or use of a night deposit slot. If desired, the cash management system shown in FIG. 3 can also be adapted to dispense loose coin, particularly if a coin holder 60 is used to accept the loose coin. In such an application, loose coin can be temporarily held in trays or coin rolls and dispensed in a loose manner, e.g., by emptying the coin trays or unrolling the coin rolls. For applications that allow for both loose and rolled coin withdrawals, it is particularly advantageous to internally handle all coins using coin rolls 26 and unwrap the coin rolls during the dispensing operation.

It can also be appreciated from FIG. 3 that the coin handling system 40, rolled coin vault 44, and rolled coin dispenser 46 can be adapted for use in other applications beyond ABM units 10. For example, coin handling functionality can be provided in standalone retail applications (e.g., for till management at large retail stores), standalone third party ABMs (e.g., those used at sports venues, restaurants, etc.), cash bailment applications, gaming and amusement applications, laundromats, quick serve restaurants, “big box” stores, any application or location having large cash/coin deposit or withdrawal needs, etc. That is, any cash management system that would benefit from the ability to accept and dispense coins can advantageously incorporated the principles discussed herein.

It has also been recognized that by allowing rolled coin 26 to be dispensed in the ways described herein, the rolled coin vault 44 stocks can fluctuate (rather than simply fill or empty in one direction) such that the number of armoured car visits to load and unload rolled coin can be minimized or even eliminated for high volume ABM units 10 or sets of ABM units 10. In other words, by integrating coin rolling and rolled coin withdrawals into a single ABM unit 10, dynamic circulation of such coins can be achieved, which further benefits the objectives of incorporating the cash management system described herein.

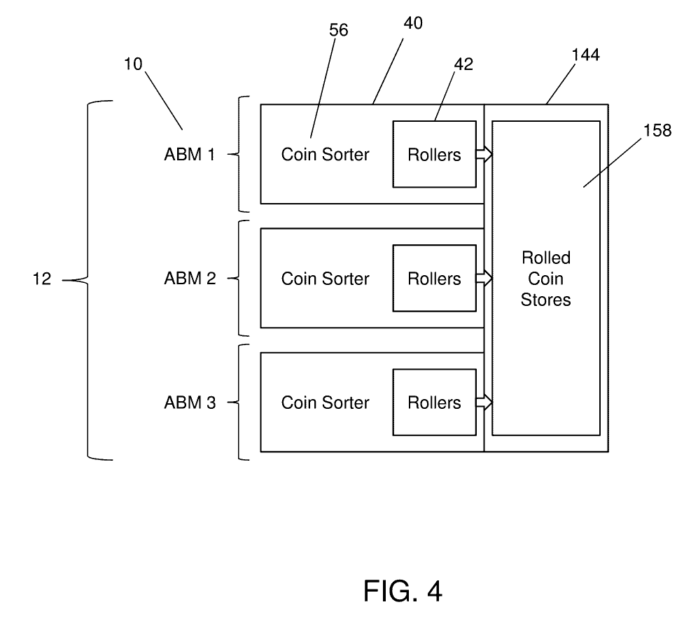

To further minimize the number of manual operations required to pick up and/or unload rolled coin 26 at the ABM units 10, it has further been recognized that multiple ABM units 10 can be configured to interface with a multi-unit rolled coin vault 144 as shown in FIG. 4. In the configuration shown in FIG. 4, the coin rolling mechanisms 42 are coupled to a multi-unit rolled coin vault 144 that includes a plurality of rolled coin stores 158 accessible to multiple ABM units 10. In this way, the stock of rolled coin 26 available to the ABM units 10 can be increased and balanced between units therefore reducing the number of manual loading and unloading actions required. The coin rolling mechanisms 42 can be configured in a manner similar to the example shown in FIG. 3, with the multi-unit rolled coin vault 144 having the ability to internally shift and balance the rolled coin 26 that is made physically accessible to the coin rolling mechanisms 42 and the rolled coin dispenser 46 for each ABM unit 10.

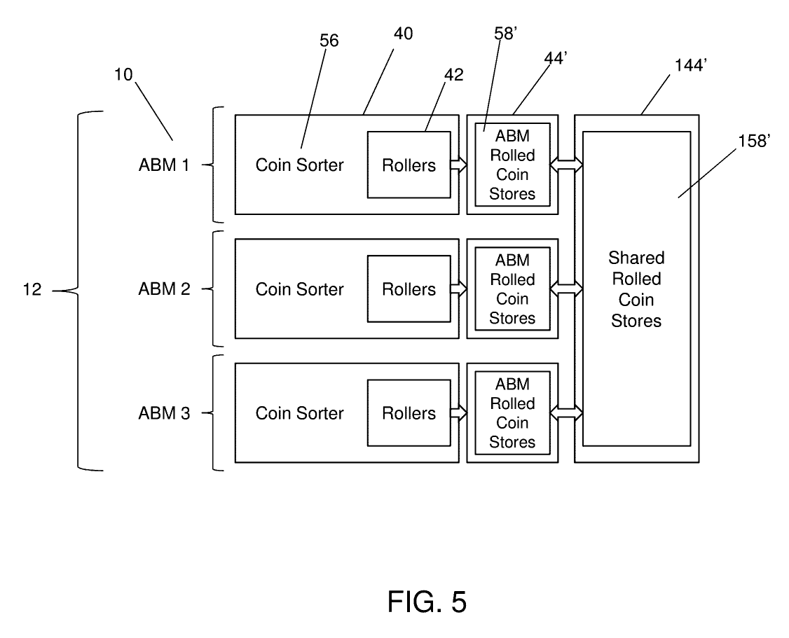

FIG. 5 illustrates another multi-unit rolled coin vault configuration in which both local rolled coin vaults 44′ and a multi-unit rolled coin vault 144′ are utilized. In this configuration, the local rolled coin vaults 44′ include rolled coin stores 58′ for the corresponding ABM unit 10, which are configured to accept and dispense rolled coin 26 within the ABM unit 10 as discussed above, but also to periodically balance stocks of rolled coin 26 by interacting with the larger stocks available in the shared rolled coin stores 158′ of the multi-unit rolled coin vault 144′.

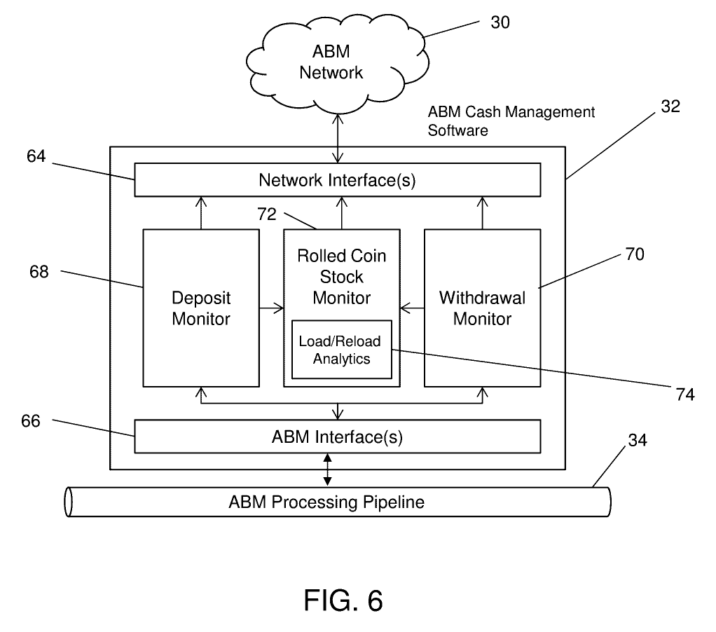

Turning now to FIG. 6, further detail regarding the ABM cash management software 32 is illustrated. The software 32 interacts and communicates with the ABM network 30 via one or more network interfaces 64, such as wired and/or wireless communication channels depending on the location of the ABM unit 10 and communication capabilities thereof. The software 32 also includes one or more ABM interfaces 66 for communicating with the various modules within the ABM unit 10 via the ABM processing pipeline 34. For example, an internal network can be established with a secure internal messaging protocol for receiving deposit messages, withdrawal messages, error messages, banking information messages, scanned cheque images, etc. In the configuration shown in FIG. 6, the software 32 includes a rolled coin stock monitor 72 that interacts with a deposit monitor 68 and a withdrawal monitor 70. The deposit monitor 68 tracks and/or is apprised of deposits as they are received and validated by the ABM unit 10. Similarly, the withdrawal monitor 70 tracks requested withdrawals of both banknotes and rolled coin 26 to enable the rolled coin stock monitor 72 to be updated accordingly. In this way, the rolled coin reserves or stocks can be balanced (if such capability exists) and loading and unloading actions initiated.

The rolled coin stock monitor 72 can also include or otherwise have access to predictive analytics 74 for determining whether or not the rolled coin vault 44, 144, 144′ should be replenished or unloaded. Since coin can be both deposited and withdrawn, a seemingly “full” rolled coin vault 44 could be depleted within a certain amount of time. By tracking patterns of use, the ABM unit 10 can intelligently determine, for example, that rolled coin withdrawals frequently occur in the morning while deposits occur near the end of the day and, as such, a depleted stock would likely be replenished for the next day's withdrawals. Using such analytics locally in an ABM unit 10 can further optimize the handling of coin and further minimize the number of manual loading and unloading actions, which often require armoured car pick-ups or deliveries. Any suitable intelligent processing or machine learning can be used to determine deposit and withdrawal patterns for acting accordingly. It can also be appreciated that the analytics can be available within the ABM unit 10 or provided by an external software program within the scope of the principles discussed herein.

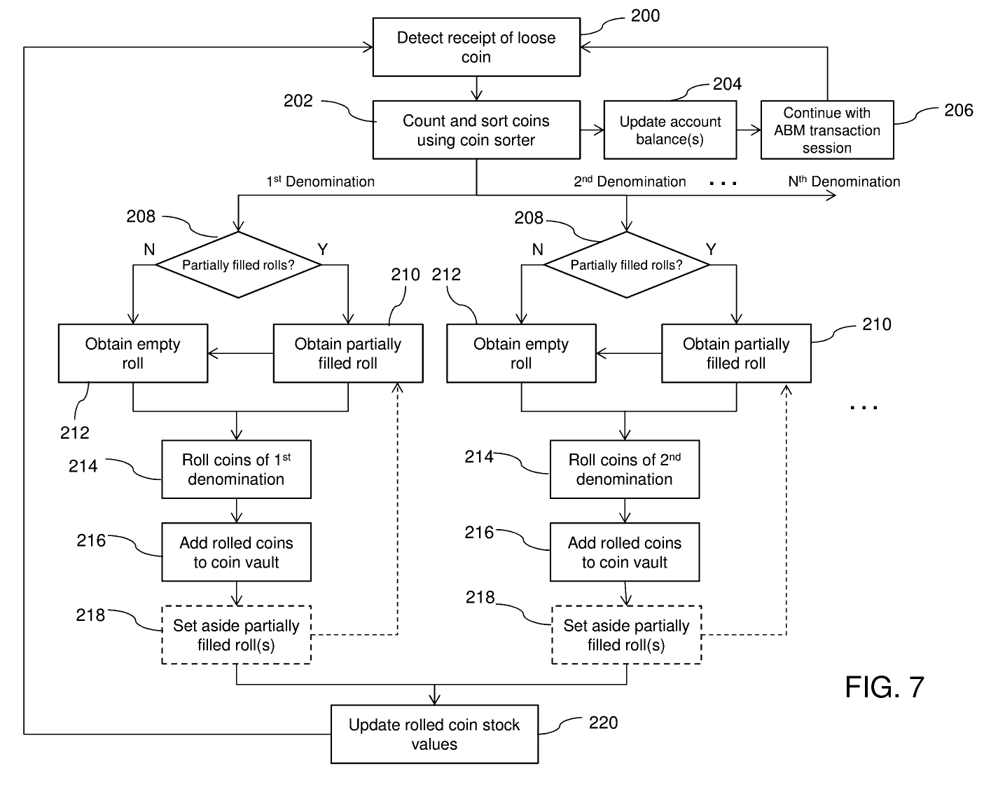

FIG. 7 illustrates a set of operations that can be performed in processing a loose coin deposit at an ABM unit 10. At 200 the coin handling system 40 detects receipt of loose coin 22 via the coin deposit acceptor 20 and counts and sorts the coins at 202 using the coin sorter 56. It can be appreciated that the counting operation at 202 can also include sub-steps of rejecting coins that cannot be detected, are of the wrong currency, etc. By sorting and counting the loose coin 22, an associated account balance can be updated at 204 to reflect the amount of coin deposited. The coins accepted by the ABM unit 10 can be rolled in various ways. For example, coin can be stacked in each denomination until the desired number of coin is reached, after which the stack is rolled and stored. In another example, an empty (or partially empty) roll can be filled as the coin is accepted, with each coin populating the roll. When the roll has reached the correct amount of coin, the roll is sealed and stored. While the loose coin 22 is being rolled, the ABM unit 10 can also enable the user to continue with their ABM transaction session at 206, e.g. to initiate a withdrawal, make another deposit, etc. As shown in FIG. 7, each denomination is handled separately to fill corresponding coin rolls 26 and thus only one of these sub-processes will be described for brevity.

At 208 the coin rolling mechanism 42 determines whether or not there are any partially filled coin rolls or partially completed stacks of coin that have been queued from a previous deposit i.e., if filling and refilling machines and/or rolls are not fully completed. Since a loose coin deposit would not necessarily include exact and consistent quantities, in at least some circumstances, partially filled rolls are left incomplete at the end of a coin rolling operation. In these circumstances, a partially filled roll is obtained at 210 and, if additional empty rolls are required, they are obtained at 212. The coins of the first denomination are then rolled at 214 and the rolled coin 26 is added to the rolled coin vault 44 at 216. If necessary, any new partially filled rolls are set aside or otherwise queued or held over for a subsequent transaction as shown in dashed lines in FIG. 7. The rolled coin stock values are then updated at 220 in order to manage coin stocks and determine if/when loading and unloading actions are required. It can be seen that operations 208-218 are similarly performed by the other coin rolling mechanisms 42 for the other denominations.

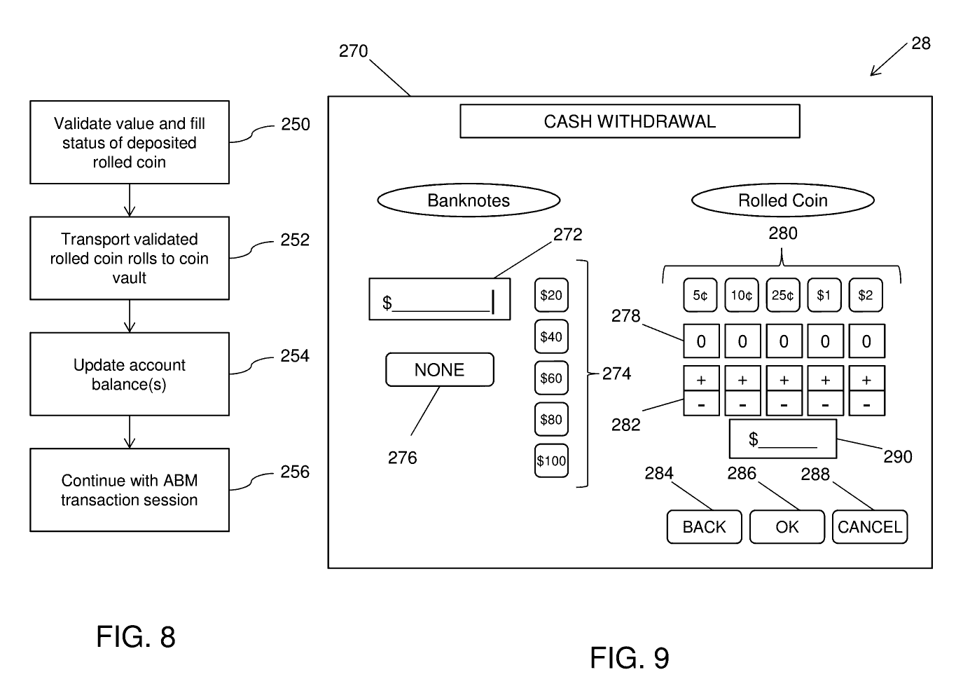

FIG. 8 illustrates the handling of pre-rolled coin 26. At 250, the values and fill status of each deposited coin roll 26 is validated. For example, weight sensors can be used to determine an expected weight for a full roll. The validated rolled coin 26 is then transported (e.g., via conveyor or other conveyance mechanism) to the coin vault 44, particularly the corresponding rolled coin store 58 for the corresponding denomination of coin. The validated rolls are also then valued and the associated account balance updated at 254. Similar to loose coin deposits, the ABM unit 14 can also enable the user to continue with their ABM transaction session at 256.

Since the ABM unit 10 carries rolled coin suitable for withdrawal, the display screen 28 can be used to provide a user interface 270 as shown in FIG. 9, that allows for the user to select rolled coin 26 as an option for a cash withdrawal. Turning to FIG. 9, while normally ABMs provide only banknote withdrawals, the ABM unit 10 described herein can also withdraw rolled coin 26 from the rolled coin stores 58. In this example, cash withdrawals can include both banknotes and rolled coin 26 unlike prior ABMs. The amount in banknotes can be separately requested similar to existing ABMs by either selecting a typical amount or manually entering an amount, or selecting a NONE button 276 to only make a rolled coin withdrawal. It can be appreciated that banknote withdrawals are typically constrained by the type of banknotes held in the ABM, e.g., $20 or $50 notes.

The user interface 270 shown in FIG. 9 also includes a rolled coin selection portion 280 that includes options to select a number of coin rolls 26 for each denomination. That is, rather than specifying a certain amount (or value) of coin, the number of rolls for each denomination are selected. In this example, coins available in the Canadian currency are shown, namely five cent, ten cent, twenty five cent, one dollar and two dollars. A roll count box 278 is used to show the number of rolls selected, plus and minus toggle buttons 282 are used to enable the user to increase or decrease the number of coin rolls 26 for each denomination, and a total coin value box 290 is used to show the cash value for the number of rolls selected. In this way, the user is provided with granular selection options to conveniently select the number of coin rolls required, since those withdrawing rolled coin 26 typically desire coin in this manner. A BACK button 284 is shown for moving to a previous screen, an OK button 286 is shown for confirming the requested withdrawal, and a CANCEL button 288 is shown for aborting the transaction. It can be appreciated that the layout and exact functionality shown in FIG. 9 is illustrative of only one particular embodiment and variations are possible while enabling rolled coin withdrawals within the principles discussed herein.

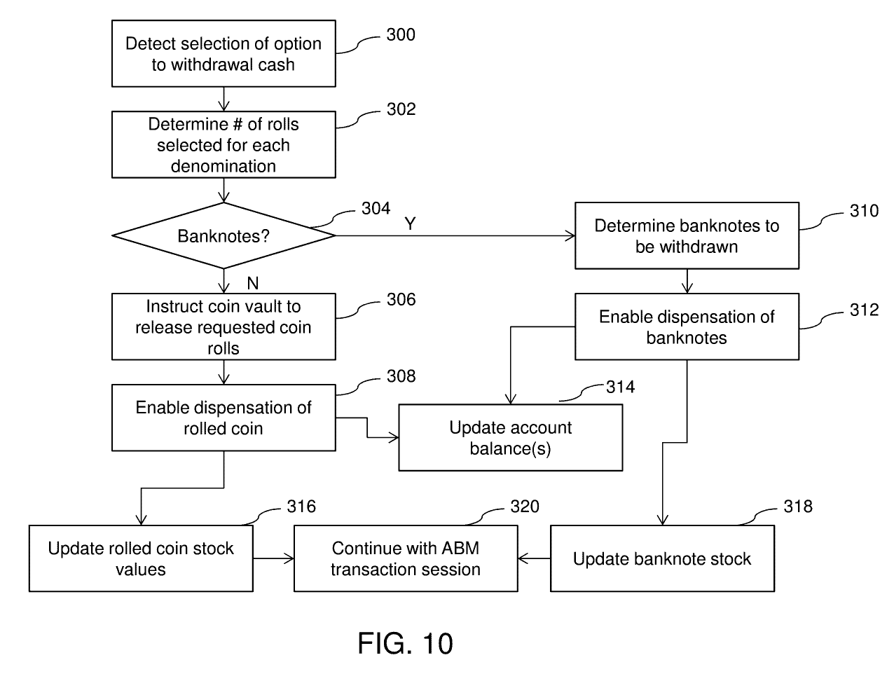

FIG. 10 illustrates a process for processing a cash withdrawal that can include a combination of both banknotes and rolled coin 26. At 300 the ABM unit 10 detects selection of an option to withdrawal cash, e.g., via a user interface displayed on the display screen 28 and detecting a touch screen or keypad selection. At 302 the ABM unit 10, via selection made using the user interface 170, determines the number of rolls selected for each denomination of rolled coin 26 (e.g., as discussed above with respect to FIG. 9). The ABM unit 10 also determines, via selections made using the user interface 170, whether or not any banknotes have been selected for withdrawal at 304. For the rolled coin selections, the rolled coin dispenser 46 is instructed to obtain the requested rolled coin 26 from the rolled coin vault 44 at 306 and enables the dispensation of the rolled coin 26 at 308 via the rolled coin dispenser opening 24. For the banknote selections, the ABM 10 determines the banknotes to be withdrawn and how many at 310 and instructs the banknote vault 50 and banknote dispenser 52 to dispense the requested banknotes at 312. After dispensing the banknotes and rolled coin 26, the account balance(s) is/are updated at 314 based on what has been withdrawn. Also, the rolled coin stock values are updated at 316 and the banknote stock(s) updated at 318 according to the quantities taken from the coin and banknote vaults 44, 50. The ABM unit 10 may then allow the user to continue with their ABM transaction session, e.g., to perform another transaction, view account balances, etc.

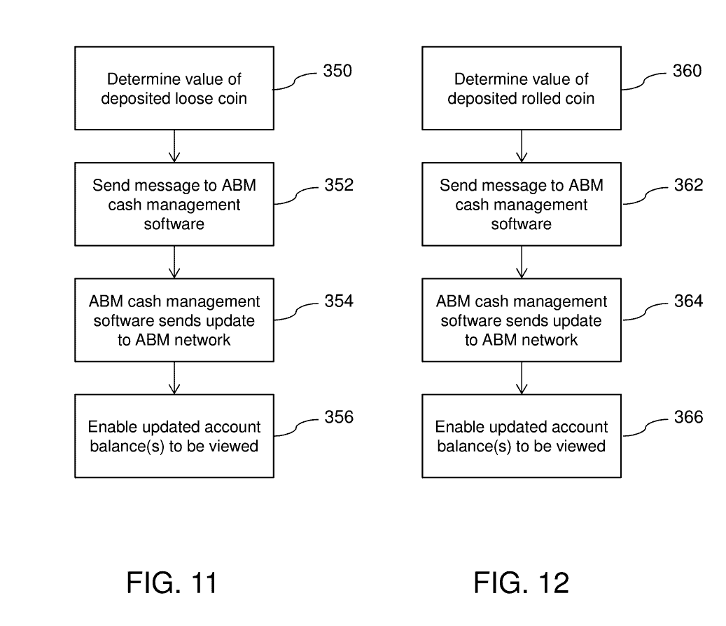

FIG. 11 illustrates a process for interacting with the ABM cash management software 32 to update the ABM network 30 regarding a loose coin deposit. At 350 the coin sorter 56 determines the value of the loose coin 22 that has been deposited, as discussed above. At 352, the coin sorter 56 sends a message to the ABM cash management software 32 with the deposited value. It can be appreciated that any messages pushed from one module to another can instead be “pulled” by monitoring activities via the processing pipeline 34. The software 32 then generates an update in accordance with the messaging and communication protocols of the ABM network 30 and sends the update to the appropriate location within the ABM network 30 at 354. The ABM unit 10 is also then able to display updated account balance information at 356, e.g., by receiving a confirmation from the ABM network 30 or based on a locally computed balance based on the transaction and previous balance.

FIG. 12 illustrates a process for interacting with the ABM cash management software 32 to update the ABM network 30 regarding a rolled coin deposit. At 360 the rolled coin validator 54 determines the value of the validated rolled coin 26 that has been deposited, as discussed above. At 362, the rolled coin validator 54 sends a message to the ABM cash management software 32 with the deposited value. The software 32 then generates an update in accordance with the messaging and communication protocols of the ABM network 30 and sends the update to the appropriate location within the ABM network 30 at 364. The ABM unit 10 is also then able to display updated account balance information at 366, e.g., by receiving a confirmation from the ABM network 30 or based on a locally computed balance based on the transaction and previous balance.

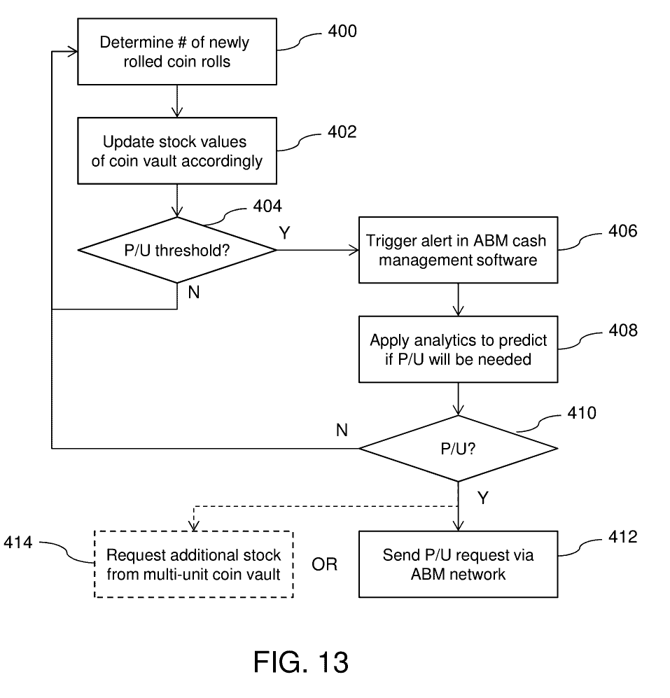

Turning now to FIG. 13, a process for managing rolled coin stock following a coin deposit is shown. At 400 the ABM cash management software 32 determines the number of newly rolled coin rolls (or deposited pre-rolled coin rolls) and updates the stock values of the coin vault 44 accordingly (e.g., by maintaining a database of values) at 402. The software 32 then determines if a pick up (P/U) threshold has been met at 404. The P/U threshold can be a fill limit indicating that the rolled coin vault 44 is near to being full and an unloading action should be considered. If the P/U threshold has not been met, the process repeats upon the next coin deposit. If the P/U threshold has been met, an alert can be triggered in the software 32 at 406. It can be appreciated that any of the modules responsible for handling and determining the number of deposited coin rolls 26 can trigger the alert, including the software itself 32. If available, the analytics 74 is executed at 408 to determine if, based on when the alert is triggered at 410, the unload action should be requested. For example, as noted above, deposit and withdrawal patterns at particular ABM units 10 can be tracked such that near full vaults 44 do not trigger an unload action since a pattern of withdrawals is expected in the near future (e.g. by the next morning). If the analytics 74 suggests that a pick-up is not required, the process can be repeated at the next coin deposit operation. However, if the analytics 74 determines that, based on when this deposit is made, a pick up should be triggered, a P/U request is initiated at 412, e.g. via the ABM network 30. For example, the financial institution can be notified to arrange an armoured car pick up. Alternatively, as shown in dashed lines, if a multi-unit vault 144 is available, the ABM unit 10 can instead trigger a rebalancing operation to transfer rolled coin 26 to the multi-unit vault 144.

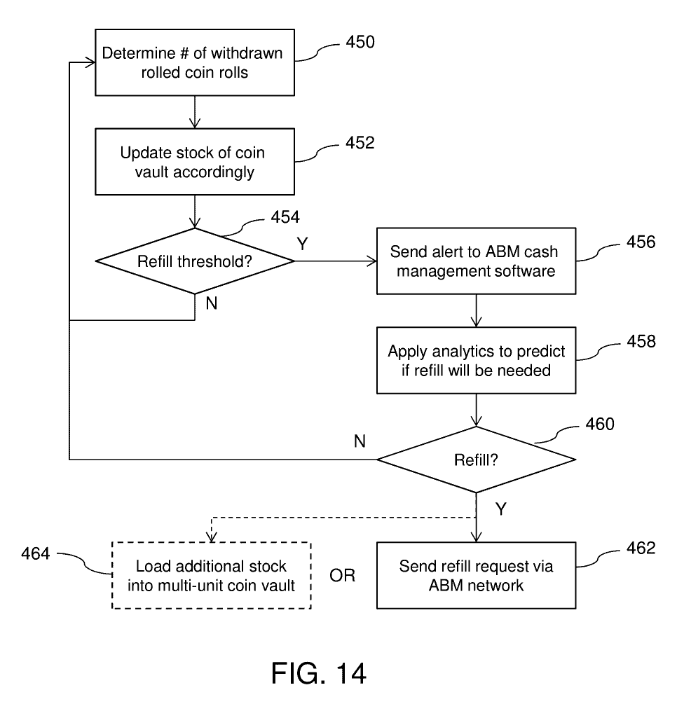

FIG. 14 illustrates a process for managing rolled coin stock following a rolled coin withdrawal. At 450 the ABM cash management software 32 determines the number of withdrawn rolled coin rolls and updates the stock values of the coin vault 44 accordingly (e.g., by maintaining a database of values) at 452. The software 32 then determines if a refill threshold has been met at 454. The refill threshold can be a depletion limit indicating that the rolled coin vault 44 is near to being empty of suitable amounts of certain denominations, and a loading action should be considered. If the refill threshold has not been met, the process repeats upon the next coin withdrawal. If the refill threshold has been met, an alert can be triggered in the software 32 at 456. It can be appreciated that any of the modules responsible for handling and determining the number of withdrawn coin rolls 26 can trigger the alert, including the software itself 32. If available, the analytics 74 is executed at 458 to determine if, based on when the alert is triggered at 460, the load action should be requested. For example, as noted above, deposit and withdrawal patterns at particular ABM units 10 can be tracked such that near empty vaults 44 do not trigger an load action since a determined pattern of deposits suggests that a suitable number of deposits are expected in the near future (e.g. by the end of business). If the analytics 74 suggests that a refill is not required, the process can be repeated at the next coin withdrawal. However, if the analytics 74 determines that, based on when this deposit is made, a refill should be triggered, a refill request is initiated at 462, e.g. via the ABM network 30. For example, the financial institution can be notified to arrange an armoured car delivery. Alternatively, as shown in dashed lines, if a multi-unit vault 144 is available, the ABM unit 10 can instead trigger a rebalancing operation to transfer rolled coin 26 from the multi-unit vault 144.

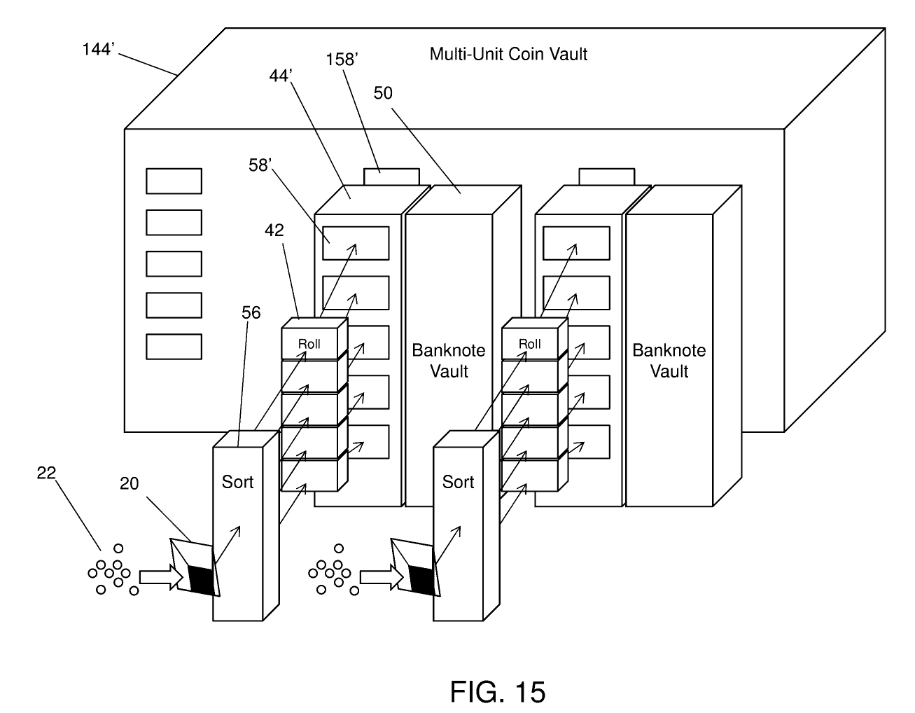

For illustrative purposes, FIG. 15 provides a partial exploded view of the components of the ABM unit 10 and multi-unit coin vault 144′ described above. It can be seen that by stacking the rolling mechanisms 42 and corresponding rolled coin stores 58′, individual denominations can be handled in parallel and with minimum complexity. Moreover, by utilizing a multi-unit vault 144′, rebalancing of local vaults 58′ can be achieved when sets of ABM units 10 are deployed together. Moreover, FIG. 15 illustrates the modularity of the coin handling devices, enabling adaptation of the presently described cash management system to various applications in addition to ABM units 10.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the ABM unit 10 or ABM network 30, any component of or related to the ABM unit 10, ABM network 30 etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A cash management system comprising:
a coin sorter for discriminating between a plurality of denominations of coin accepted by a coin acceptor;
at least one coin roller coupled to the coin sorter, for rolling the plurality of denominations of coin output by the coin sorter;
at least one rolled coin store coupled to the at least one coin roller, for storing rolled coin in the plurality of denominations output by the at least one coin roller; and
a rolled coin dispenser coupled to the at least one rolled coin store, for obtaining rolled coin requested in a withdrawal.

2. The system of claim 1, comprising a separate coin roller for each of the plurality of denominations of coin.

3. The system of claim 2, comprising a separate rolled coin store for each of the plurality of denominations of coin.

4. The system of claim 1, comprising a coin vault for securely containing the at least one rolled coin store.

5. The system of claim 1, further comprising a rolled coin validator coupled to the at least one rolled coin store for receiving pre-rolled coin and validating each roll for accuracy prior to accepting a corresponding deposit.

6. The system of claim 1, further comprising a banknote vault for storing one or more banknote denominations and a banknote dispenser to enable cash withdrawals comprising both coins and banknotes.

7. The system of claim 1, incorporated into a financial institution transaction device.

8. The system of claim 7, wherein the financial institution transaction device is an automated banking machine (ABM).

9. The system of claim 1, further comprising an outlet comprising an interface for a coin holder to receive coin from the rolled coin dispenser.

10. The system of claim 6, further comprising a user interface comprising options for selecting both cash and coin amounts for a same withdrawal.

11. The system of claim 1, wherein the at least one rolled coin store comprises at least one multi-unit rolled coin store that is coupled to a plurality of cash management systems.

12. The system of claim 11, wherein the at least one multi-unit rolled coin store is incorporated into a multi-unit rolled coin vault securely coupled to a plurality of ABM units.

13. The system of claim 1, incorporated into an automated banking machine (ABM) comprising a housing supporting a display screen, a loose coin acceptor, and a rolled coin dispenser.

14. The system of claim 13, further comprising a banknote dispenser.

15. The system of claim 13, further comprising a card reader for enabling user access to the ABM.

16. A method for enabling cash withdrawals, the method comprising:
providing, in a user interface, a banknote withdrawal option and a rolled coin withdrawal option;
enabling, by the rolled coin withdrawal option, selection of one or more coin rolls for each of a plurality of coin denominations; and
after detecting confirmation of selections made in either or both of the banknote withdrawal option and the rolled coin withdrawal option, instructing a banknote dispenser to dispense one or more banknotes and at least one coin roll.

17. The method of claim 16, wherein the user interface displays the banknote withdrawal option and the rolled coin withdrawal option on the same screen.

18. The method of claim 16, further comprising processing a cash withdrawal by:
determining a number of withdrawn coin rolls;
updating values indicative of a stock of rolled coins in the ABM;
determining if at least a portion of the stock of rolled coins in the ABM should be added to the ABM; and
when it is determined that stock of rolled coins should be added, sending a request for same via an ABM communication network.

19. A method of processing loose coin deposits, the method comprising:
in response to receiving a plurality of loose coins, counting, validating, and sorting the plurality of loose coins; and
for each of at least one coin denomination:
performing at least one of: i) filling a partially filled roll if available from a previous loose coin deposit and rolling the filled roll, and ii) completing a partial stack of coin and rolling the completed stack;
performing at least one of: i) obtaining an empty roll, filling the empty roll, and rolling the filled roll, and ii) rolling a newly completed stack of coin; and
adding at least one coin roll to a rolled coin store in an ABM.

20. The method of claim 19, further comprising processing a rolled coin deposit by:
determining and validating a number of newly rolled coin rolls;
updating values indicative of a stock of rolled coins in the ABM;
determining if at least a portion of the stock of rolled coins in the ABM should be removed from the ABM; and
when it is determined that stock of rolled coins should be removed, sending a request for same via an ABM communication network.
